(19) United States
(12) Patent Application Publication
(10) Pub. No.: US 2007/0060226 A1
(43) Pub. Date: Mar. 15, 2007

(54) Variable action gauge in a turn-based video game

(75) Inventors: Hironobu Sakaguchi, Honolulu, HI (US); Eiichiro Ishige, Tokyo (JP)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/221,788

(22) Filed: Sep. 9, 2005

(51) Int. Cl. A63F 13/00

(52) U.S. Cl. 463/1

(57) ABSTRACT

Methods and systems for affecting a power level of an action performed by a character in a video game are disclosed. In a turn-based video game, a player-character may decide whether to perform the action with a default power level, or to charge the action to a higher predetermined level, and thereby delaying the turn in which the action is performed. The action charges a predetermined amount per turn, and when an action meter is full, the charged action is performed. Actions by other characters, rewards, and penalties in the video game may favorably or adversely affect the rate at which the charge meter charges.

### BACKGROUND

Computer and video games have matured from the likes of “Pong” into epic adventures having rich storylines, photorealistic graphics, and complex interaction systems, thereby allowing a player to immerse herself in the alternative reality that is emulated by the video game. As used herein, video games may include, but are not limited to, any game played on a data processing device. Examples of video games may include computer games, game console games (e.g., playable on the Xbox®, PlayStation®, and/or Nintendo® brand game consoles), coin-operated or token-operated arcade games, portable gaming device games (e.g., playable on the Nokia N-Gage®, PlayStation Portable, Nintendo DS, a mobile phone, etc.), or other software-driven games.

Video games come in many genres, such as first-person shooters (FPS), role-playing games (RPG), simulation, sports, strategy, and driving, to name a few. Each video game is not necessarily limited to a single genre, and may indeed encompass multiple genres. A RPG generally refers to a game in which each participant assumes the role of a character in the game (such as an adventurer, monster, or other player-character) that can interact within the game's virtual world. A character controlled by a player/user is referred to as a player-character (PC). A computer controlled character is referred to as a non-player-character (NPC).

Most RPGs, if not all, use a fighting system through which PCs and NPCs engage in simulated fights and/or battles, referred to herein as character engagement. As used herein, the system used by a RPG to simulate fighting is referred to as a battle system. The battle system is typically implemented as a software module of the video game. One known battle system is a real-time battle system, whereby player-characters take actions as soon as input is received from the player, without waiting for another character to take an action. Another known battle system can broadly be referred to as a turn-based battle system. In a turn-based battle system each character performs an action in a predetermined order, such as a continuous sequential order of all player-characters and non-player-characters involved in the character engagement until the character engagement is resolved, e.g., one character or team wins.

A known variation of the turn-based battle system is to modify the sequential order based on a quickness attribute associated with each character in the character engagement. That is, a character with a higher quickness value may be able to attack more often than a character with a lower quickness value. Each character then performs some action in the modified order. The action of PCs is based on user input provided by the player (i.e., user of the video game), whereas the actions of NPCs are controlled by the video game logic.

### SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Some aspects of the present invention are directed to affecting a power level of a character's action (e.g., casting a spell, defending against an attack, healing wounds, etc.) in a turn-based video game. At the beginning of a turn, a user can decide whether to perform an action at a default power level, or whether to charge the action a predetermined amount. Depending on how much the player wants to charge the action, the charge time may take one or more turns to fill a charge meter corresponding to the player-character. The charge meter is incremented a certain amount per turn, e.g., based on character attributes of the player-character.

According to an illustrative aspect of the invention, actions of other characters (player-characters and non-player-characters) in the video game may affect the rate at which the charge meter fills up. For example, an enemy player may attack the player-character, thereby reducing the charge meter a specified amount. In another example, an enemy character may cast a “slow charge” spell on the player-character, thereby reducing the rate at which the charge meter increments per turn. Other adverse affecting penalties may also be used. Similar actions by friendly characters may favorably affect the charge meter rate, e.g., as a result of “speed charge” spells, or other similar rewards.

### BRIEF DESCRIPTION OF THE DRAWINGS

A more complete understanding of the various features and advantages thereof may be acquired by referring to the following description in consideration of the accompanying drawings, in which like reference numbers indicate like features, and wherein:

FIG. 1 illustrates a gaming system that may be used according to an illustrative embodiment of the invention.

FIG. 2 illustrates a block diagram of the gaming system shown in FIG. 1.

FIG. 3 illustrates a block diagram of a network gaming system according to an illustrative embodiment of the invention.

FIG. 4 illustrates another block diagram of an online gaming environment according to an illustrative embodiment of the invention.

FIG. 5 illustrates a block diagram of a general purpose data processing device that may be used according to one or more illustrative aspects of the invention.

FIGS. 6A and 6B illustrate a turn sequence during a non-charged action according to one or more illustrative aspects of the invention.

FIGS. 7A-7C illustrate a turn sequence during a charged action according to one or more illustrative aspects of the invention.

FIG. 8 illustrates a resultant turn sequence after the action charging of FIGS. 7A-7C is complete, according to one or more illustrative aspects of the invention.

FIG. 9 illustrates a flow chart for performing an action charging method according to one or more illustrative aspects of the invention.

FIG. 10 illustrates a screen display of a turn based video game according to one or more illustrative aspects of the invention.

FIG. 11 illustrates a flowchart for performing an variable action gauge method according to one or more illustrative aspects of the invention.

FIGS. 12A, 12B, and 12C illustrate screen displays during sequential turns in a video game according to one or more illustrative aspects of the invention.

FIG. 13 illustrates a screen display when a charge meter is full according to one or more illustrative aspects of the invention.

FIG. 14 illustrates a video game turn timeline according to one or more illustrative aspects of the invention.

### DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

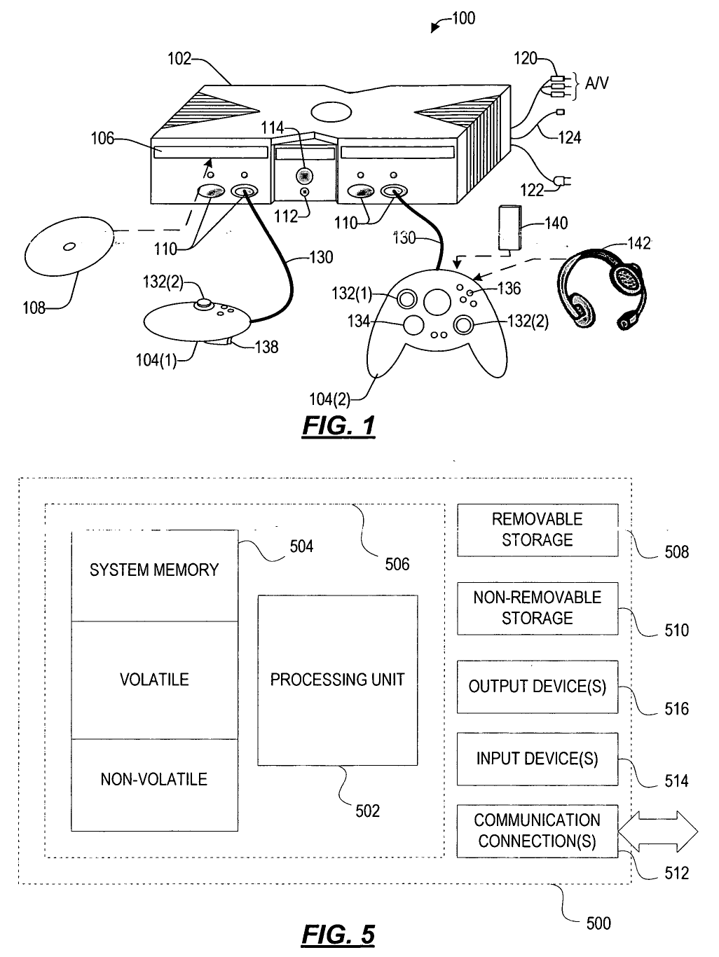

FIG. 1 illustrates an example of a suitable gaming system environment 100 on which video games incorporating one or more aspects of the present invention may be played. The gaming system environment 100 is only one example of a suitable computing environment and is not intended to suggest any limitation as to the scope of use or functionality of the invention. Neither should the gaming system environment 100 be interpreted as having any dependency or requirement relating to any one or combination of components illustrated in the illustrative operating gaming system environment 100.

Various aspects are operational with numerous other general purpose or special purpose computing system environments or configurations. Examples of well known computing systems, environments, and/or configurations that may be suitable for use with various aspects include, but are not limited to, personal computers; server computers; portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; electronic game consoles, distributed computing environments that include any of the above systems or devices; and the like.

Various features may be described in the general context of computer-executable instructions, such as program modules, being executed by a computer. Generally, program modules include routines, programs, objects, components, data structures, etc. that perform particular tasks or implement particular abstract data types. Various features may also be practiced in distributed computing environments where tasks are performed by remote processing devices that are linked through a communications network. In a distributed computing environment, program modules may be located in both local and remote computer storage media including memory storage devices.

FIG. 1 shows an exemplary gaming system 100. Gaming system 100 may include a game console 102 and up to four controllers, as represented by controllers 104(1) and 104(2). The game console 102 is equipped with an internal hard disk drive and a portable media drive 106 that supports various forms of portable storage media as represented by optical storage disc 108. Examples of suitable portable storage media include DVD, CD-ROM, game discs, and so forth.

Game console 102 has four slots 110 on its front face to support up to four controllers, although the number and arrangement of slots may be modified. A power button 112 and an eject button 114 are also positioned on the front face of the game console 102. The power button 112 switches power to the game console and the eject button 114 alternately opens and closes a tray of the portable media drive 106 to allow insertion and extraction of the storage disc 108.

Game console 102 may connect to a television or other display (not shown) via A/V interfacing cables 120. The display (not shown) may be referred to herein as a video game display device. A power cable 122 provides power to the game console. Game console 102 may further be configured with broadband network capabilities, as represented by the cable or modem connector 124 to facilitate access to a network, such as the Internet.

Each controller 104 may be coupled to the game console 102 via a wire or wireless interface. In the illustrated implementation, the controllers are USB (Universal Serial Bus) compatible and are connected to the console 102 via USB cables 130. Controller 102 may be equipped with any of a wide variety of user interaction mechanisms. As illustrated in FIG. 1, each controller 104 is equipped with two thumbsticks 132(1) and 132(2), a D-pad 134, buttons 136 (e.g., ‘A’, ‘B’, ‘X’, ‘Y’), and two triggers 138. These mechanisms are merely representative, and other known gaming mechanisms may be substituted for or added to those shown in FIG. 1.

A memory unit (MU) 140 may be inserted into the controller 104 to provide additional and portable storage. Portable memory units enable users to store game parameters and user accounts, and port them for play on other consoles. In the described implementation, each controller is configured to accommodate two memory units 140, although more or less than two units may be employed in other implementations. A headset 142 may be connected to the controller 104 or game console 102 to provide audio communication capabilities. Headset 142 may include a microphone for audio input and one or more speakers for audio output.

Gaming system 100 is capable of playing, for example, games, music, and videos. With the different storage offerings, titles can be played from the hard disk drive or the portable medium 108 in drive 106, from an online source, or from a memory unit 140. For security, in some embodiments executable code can only be run from the portable medium 108. A sample of what gaming system 100 is capable of playing include game titles played from CD and DVD discs, from the hard disk drive, or from an online source; digital music played from a CD in the portable media drive 106, from a file on the hard disk drive (e.g., Windows Media Audio (WMA) format), or from online streaming sources; and digital audio/video played from a DVD disc in the portable media drive 106, from a file on the hard disk drive (e.g., Active Streaming Format), or from online streaming sources.

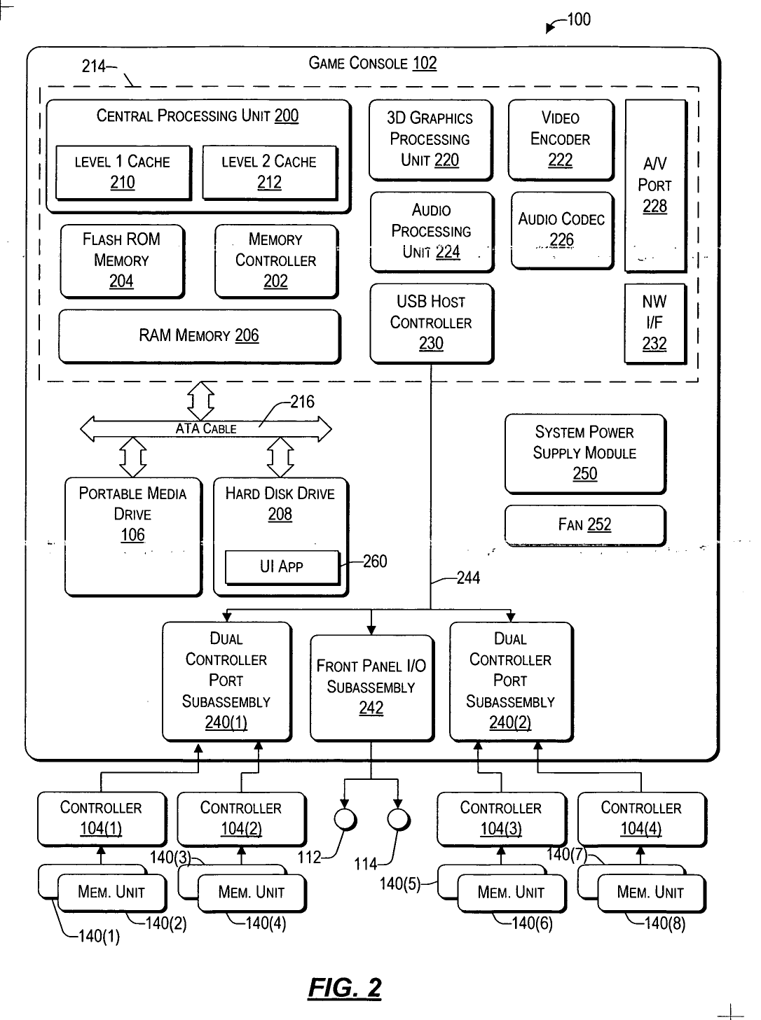

FIG. 2 shows functional components of the gaming system 100 in more detail. The game console 102 has a central processing unit (CPU) 200 and a memory controller 202 that facilitates processor access to various types of memory, including a flash ROM (Read Only Memory) 204, a RAM (Random Access Memory) 206, a hard disk drive 208, and the portable media drive 106. The CPU 200 is equipped with a level I cache 210 and a level 2 cache 212 to temporarily store data and hence reduce the number of memory access cycles, thereby improving processing speed and throughput.

The CPU 200, memory controller 202, and various memory devices are interconnected via one or more buses, including serial and parallel buses, a memory bus, a peripheral bus, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

As one suitable implementation, the CPU 200, memory controller 202, ROM 204, and RAM 206 are integrated onto a common module 214. In this implementation, ROM 204 is configured as a flash ROM that is connected to the memory controller 202 and a ROM bus (not shown). RAM 206 is configured as multiple DDR SDRAM (Double Data Rate Synchronous Dynamic RAM) that are independently controlled by the memory controller 202 via separate buses (not shown). The hard disk drive 208 and portable media drive 106 are connected to the memory controller via the PCI bus and an ATA (AT Attachment) bus 216.

A 3D graphics processing unit 220 and a video encoder 222 form a video processing pipeline for high speed and high resolution graphics processing. Data is carried from the graphics processing unit 220 to the video encoder 222 via a digital video bus (not shown). An audio processing unit 224 and an audio codec (coder/decoder) 226 form a corresponding audio processing pipeline with high fidelity and stereo processing. Audio data is carried between the audio processing unit 224 and the audio codec 226 via a communication link (not shown). The video and audio processing pipelines output data to an A/V (audio/video) port 228 for transmission to the television or other display. In the illustrated implementation, the video and audio processing components 220-228 are mounted on the module 214.

Also implemented on the module 214 are a USB host controller 230 and a network interface 232. The USB host controller 230 is coupled to the CPU 200 and the memory controller 202 via a bus (e.g., PCI bus) and serves as host for the peripheral controllers 104(1)-104(4). The network interface 232 provides access to a network (e.g., Internet, home network, etc.) and may be any of a wide variety of various wire or wireless interface components including an Ethernet card, a modem, a Bluetooth module, a cable modem, and the like.

The game console 102 has two dual controller support subassemblies 240(1) and 240(2), with each subassembly supporting two game controllers 104(1)-104(4). A front panel I/O subassembly 242 supports the functionality of the power button 112 and the eject button 114, as well as any LEDs (light emitting diodes) or other indicators exposed on the outer surface of the game console. The subassemblies 240(1), 240(2), and 242 are coupled to the module 214 via one or more cable assemblies 244.

Eight memory units 140(1)-140(8) are illustrated as being connectable to the four controllers 104(1)-104(4), i.e., two memory units for each controller. Each memory unit 140 offers additional storage on which games, game parameters, and other data may be stored. When inserted into a controller, the memory unit 140 can be accessed by the memory controller 202.

A system power supply module 250 provides power to the components of the gaming system 100. A fan 252 cools the circuitry within the game console 102.

The game console 102 implements a uniform media portal model that provides a consistent user interface and navigation hierarchy to move users through various entertainment areas. The portal model offers a convenient way to access content from multiple different media types—game data, audio data, and video data—regardless of the media type inserted into the portable media drive 106.

To implement the uniform media portal model, a console user interface (UI) application 260 is stored on the hard disk drive 208. When the game console is powered on, various portions of the console application 260 are loaded into RAM 206 and/or caches 210, 212 and executed on the CPU 200. The console application 260 presents a graphical user interface that provides a consistent user experience when navigating to different media types available on the game console.

The gaming system 100 may be operated as a standalone system by simply connecting the system to a television or other display. In this standalone mode, the gaming system 100 allows one or more players to play games, watch movies, or listen to music. However, with the integration of broadband connectivity made available through the network interface 232, the gaming system 100 may further be operated as a participant in a larger network gaming community. This network gaming environment is described next.

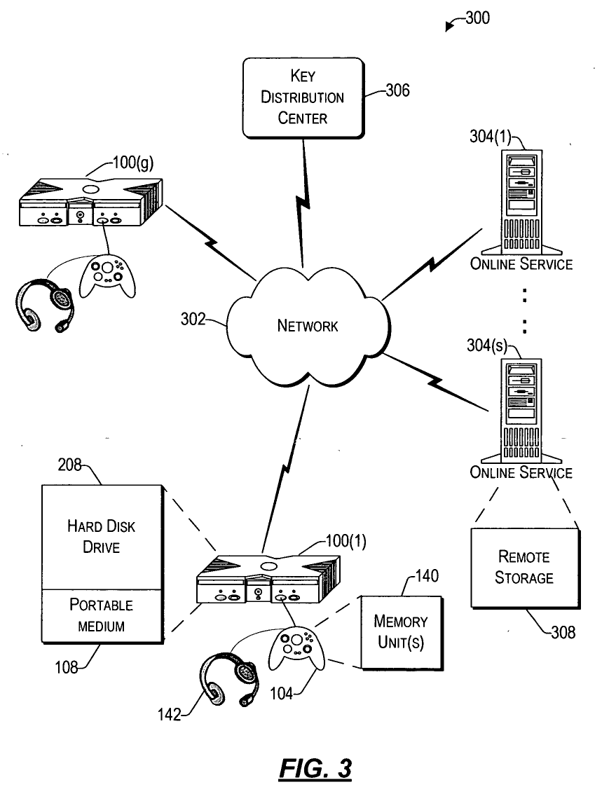

FIG. 3 shows an exemplary network gaming environment 300 that interconnects multiple gaming systems 100(1), . . . , 100(g) via a network 302. The network 302 represents any of a wide variety of data communications networks. It may include public portions (e.g., the Internet) as well as private portions (e.g., a residential Local Area Network (LAN)), as well as combinations of public and private portions. Network 302 may be implemented using any one or more of a wide variety of conventional communications media including both wired and wireless media. Any of a wide variety of communications protocols can be used to communicate data via network 302, including both public and proprietary protocols. Examples of such protocols include TCP/IP, IPX/SPX, NetBEUI, etc.

In addition to gaming systems 100, one or more online services 304(1), . . . , 304(s) may be accessible via the network 302 to provide various services for the participants, such as hosting online games, serving downloadable music or video files, hosting gaming competitions, serving streaming audio/video files, and the like. The network gaming environment 300 may further involve a key distribution center 306 that plays a role in authenticating individual players and/or gaming systems 100 to one another as well as online services 304. The distribution center 306 distributes keys and service tickets to valid participants that may then be used to form games amongst multiple players or to purchase services from the online services 304.

The network gaming environment 300 introduces another memory source available to individual gaming systems 100—online storage. In addition to the portable storage medium 108, the hard disk drive 208, and the memory unit(s) 140, the gaming system 100(1) can also access data files available at remote storage locations via the network 302, as exemplified by remote storage 308 at online service 304(s).

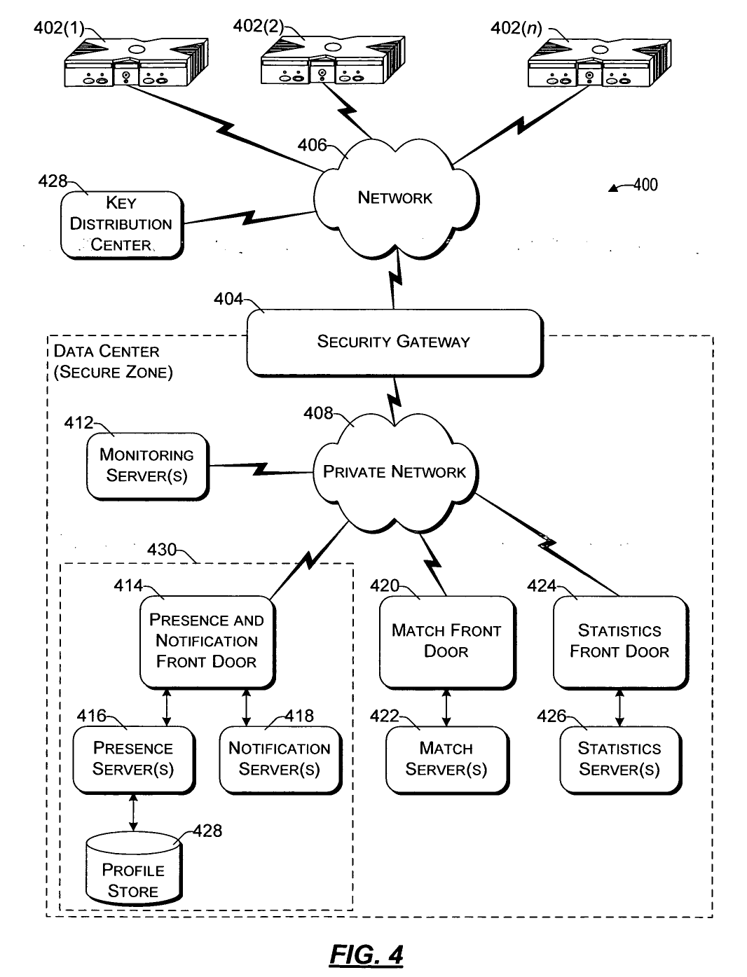

FIG. 4 is a block diagram of another illustrative online gaming environment 400, e.g. XBOX® LIVE by Microsoft Corporation of Redmond, Wash. Multiple game consoles 402(1), 402(2), . . . , 402(n) are coupled to a security gateway 404 via a network 406. Each game console 402 can be, for example, a game console 102 of FIG. 1 or FIG. 2. Network 406 represents any one or more of a variety of conventional data communications networks. Network 406 will typically include packet switched networks, but may also include circuit switched networks. Network 406 can include wire and/or wireless portions. In one exemplary implementation, network 406 includes the Internet and may optionally include one or more local area networks (LANs) and/or wide area networks (WANs). At least a part of network 406 is a public network, which refers to a network that is publicly-accessible. Virtually anyone can access the public network.

In some situations, network 406 includes a LAN (e.g., a home network), with a routing device situated between game console 402 and security gateway 404. This routing device may perform network address translation (NAT), allowing the multiple devices on the LAN to share the same IP address on the Internet, and also operating as a firewall to protect the device(s) on the LAN from access by malicious or mischievous users via the Internet.

Security gateway 404 operates as a gateway between public network 406 and a private network 408. Private network 408 can be any of a wide variety of conventional networks, such as a local area network. Private network 408, as well as other devices discussed in more detail below, is within a data center 410 that operates as a secure zone. Data center 410 is made up of trusted devices communicating via trusted communications. Thus, encryption and authentication within secure zone 410 is not necessary. The private nature of network 408 refers to the restricted accessibility of network 408—access to network 408 is restricted to only certain individuals (e.g., restricted by the owner or operator of data center 410).

Security gateway 404 is a cluster of one or more security gateway computing devices. These security gateway computing devices collectively implement security gateway 404. Security gateway 404 may optionally include one or more conventional load balancing devices that operate to direct requests to be handled by the security gateway computing devices to appropriate ones of those computing devices. This directing or load balancing is performed in a manner that attempts to balance the load on the various security gateway computing devices approximately equally (or alternatively in accordance with some other criteria).

Also within data center 410 are: one or more monitoring servers 412; one or more presence and notification front doors 414, one or more presence servers 416, one or more notification servers 418, and a profile store 428 (collectively implementing a presence and notification service or system 430); one or more match front doors 420 and one or more match servers 422 (collectively implementing a match service); and one or more statistics front doors 424 and one or more statistics servers 426 (collectively implementing a statistics service). The servers 416, 418, 422, and 426 provide services to game consoles 402, and thus can be referred to as service devices. Other service devices may also be included in addition to, and/or in place of, one or more of the servers 416, 418, 422, and 426. Additionally, although only one data center is shown in FIG. 4, alternatively multiple data centers may exist with which game consoles 402 can communicate. These data centers may operate independently, or alternatively may operate collectively (e.g., to make one large data center available to game consoles 102,402).

Game consoles 402 are situated remotely from data center 410, and access data center 410 via network 406. A game console 402 desiring to communicate with one or more devices in the data center logs in to the data center and establishes a secure communication channel between the console 402 and security gateway 404. Game console 402 and security gateway 404 encrypt and authenticate data packets being passed back and forth, thereby allowing the data packets to be securely transmitted between them without being understood by any other device that may capture or copy the data packets without breaking the encryption. Each data packet communicated from game console 402 to security gateway 404, or from security gateway 404 to game console 402 can have data embedded therein. This embedded data is referred to as the content or data content of the packet. Additional information may also be inherently included in the packet based on the packet type (e.g., a heartbeat packet).

The secure communication channel between a console 402 and security gateway 404 is based on a security ticket. Console 402 authenticates itself and the current user(s) of console 402 to a key distribution center 428 and obtains, from key distribution center 428, a security ticket. Console 402 then uses this security ticket to establish the secure communication channel with security gateway 404. In establishing the secure communication channel with security gateway 404, the game console 402 and security gateway 404 authenticate themselves to one another and establish a session security key that is known only to that particular game console 402 and the security gateway 404. This session security key is used to encrypt data transferred between the game console 402 and the security gateway cluster 404, so no other devices (including other game consoles 402) can read the data. The session security key is also used to authenticate a data packet as being from the security gateway 404 or game console 402 that the data packet alleges to be from. Thus, using such session security keys, secure communication channels can be established between the security gateway 404 and the various game consoles 402.

Once the secure communication channel is established between a game console 402 and the security gateway 404, encrypted data packets can be securely transmitted between the two. When the game console 402 desires to send data to a particular service device in data center 410, the game console 402 encrypts the data and sends it to security gateway 404 requesting that it be forwarded to the particular service device(s) targeted by the data packet. Security gateway 404 receives the data packet and, after authenticating and decrypting the data packet, encapsulates the data content of the packet into another message to be sent to the appropriate service via private network 408. Security gateway 404 determines the appropriate service for the message based on the requested service(s) targeted by the data packet.

Similarly, when a service device in data center 410 desires to communicate data to a game console 402, the data center sends a message to security gateway 404, via private network 408, including the data content to be sent to the game console 402 as well as an indication of the particular game console 402 to which the data content is to be sent. Security gateway 404 embeds the data content into a data packet, and then encrypts the data packet so it can only be decrypted by the particular game console 402 and also authenticates the data packet as being from the security gateway 404.

Although discussed herein as primarily communicating encrypted data packets between security gateway 404 and a game console 402, alternatively some data packets may be partially encrypted (some portions of the data packets are encrypted while other portions are not encrypted). Which portions of the data packets are encrypted and which are not can vary based on the desires of the designers of data center 410 and/or game consoles 402. For example, the designers may choose to allow voice data to be communicated among consoles 402 so that users of the consoles 402 can talk to one another—the designers may further choose to allow the voice data to be unencrypted while any other data in the packets is encrypted. Additionally, in another alternative, some data packets may have no portions that are encrypted (that is, the entire data packet is unencrypted). It should be noted that, even if a data packet is unencrypted or only partially encrypted, all of the data packet can still be authenticated.

Each security gateway device in security gateway 404 is responsible for the secure communication channel with typically one or more game consoles 402, and thus each security gateway device can be viewed as being responsible for managing or handling one or more game consoles. The various security gateway devices may be in communication with each other and communicate messages to one another. For example, a security gateway device that needs to send a data packet to a game console that it is not responsible for managing may send a message to all the other security gateway devices with the data to be sent to that game console. This message is received by the security gateway device that is responsible for managing that game console and sends the appropriate data to that game console. Alternatively, the security gateway devices may be aware of which game consoles are being handled by which security gateway devices—this may be explicit, such as each security gateway device maintaining a table of game consoles handled by the other security gateway devices, or alternatively implicit, such as determining which security gateway device is responsible for a particular game console based on an identifier of the game console.

Monitoring server(s) 412 operate to inform devices in data center 410 of an unavailable game console 402 or an unavailable security gateway device of security gateway 404. Game consoles 402 can become unavailable for a variety of different reasons, such as a hardware or software failure, the console being powered-down without logging out of data center 410, the network connection cable to console 402 being disconnected from console 402, other network problems (e.g., the LAN that the console 402 is on malfunctioning), etc. Similarly, a security gateway device of security gateway 404 can become unavailable for a variety of different reasons, such as hardware or software failure, the device being powered-down, the network connection cable to the device being disconnected from the device, other network problems, etc.

Each of the security gateway devices in security gateway 404 is monitored by one or more monitoring servers 412, which detect when one of the security gateway devices becomes unavailable. In the event a security gateway device becomes unavailable, monitoring server 412 sends a message to each of the other devices in data center 410 (servers, front doors, etc.) that the security gateway device is no longer available. Each of the other devices can operate based on this information as it sees fit (e.g., it may assume that particular game consoles being managed by the security gateway device are no longer in communication with data center 410 and perform various clean-up operations accordingly). Alternatively, only certain devices may receive such a message from the monitoring server 412 (e.g., only those devices that are concerned with whether security gateway devices are available).

Security gateway 404 monitors the individual game consoles 402 and detects when one of the game consoles 402 becomes unavailable. When security gateway 404 detects that a game console is no longer available, security gateway 404 sends a message to monitoring server 412 identifying the unavailable game console. In response, monitoring server 412 sends a message to each of the other devices in data center 410 (or alternatively only selected devices) that the game console is no longer available. Each of the other devices can then operate based on this information as it sees fit.

Presence server(s) 416 hold and process data concerning the status or presence of a given user logged in to data center 410 for online gaming. Notification server(s) 418 maintains multiple notification queues of outgoing messages destined for a player logged in to data center 410. Presence and notification front door 414 is one or more server devices that operate as an intermediary between security gateway 404 and servers 416 and 418. One or more load balancing devices (not shown) may be included in presence and notification front door 414 to balance the load among the multiple server devices operating as front door 414. Security gateway 404 communicates messages for servers 416 and 418 to the front door 414, and the front door 414 identifies which particular server 416 or particular server 418 the message is to be communicated to. By using front door 414, the actual implementation of servers 416 and 418, such as which servers are responsible for managing data regarding which users, is abstracted from security gateway 404. Security gateway 404 can simply forward messages that target the presence and notification service to presence and notification front door 414 and rely on front door 414 to route the messages to the appropriate one of server(s) 416 and server(s) 418.

Match server(s) 422 hold and process data concerning the matching of online players to one another. An online user is able to advertise a game available for play along with various characteristics of the game (e.g., the location where a football game will be played, whether a game is to be played during the day or at night, the user's skill level, etc.). These various. characteristics can then be used as a basis to match up different online users to play games together. Match front door 420 includes one or more server devices (and optionally a load balancing device(s)) and operates to abstract match server(s) 422 from security gateway 404 in a manner analogous to front door 414 abstracting server(s) 416 and server(s) 418.

Statistics server(s) 426 hold and process data concerning various statistics for online games. The specific statistics used can vary based on the game designer's desires (e.g., the top ten scores or times, a world ranking for all online players of the game, a list of users who have found the most items or spent the most time playing, etc.). Statistics front door 426 includes one or more server devices (and optionally a load balancing device(s)) and operates to abstract statistics server(s) 426 from security gateway 404 in a manner analogous to front door 414 abstracting server(s) 416 and server(s) 418.

Thus, it can be seen that security gateway 404 operates to shield devices in the secure zone of data center 410 from the untrusted, public network 406. Communications within the secure zone of data center 410 need not be encrypted, as all devices within data center 410 are trusted. However, any information to be communicated from a device within data center 410 to a game console 402 passes through security gateway cluster 404, where it is encrypted in such a manner that it can be decrypted by only the game console 402 targeted by the information.

One or more aspects of the invention may be embodied in computer-executable instructions (i.e., software) stored in RAM memory 206, non-volatile memory 108, 208, 308, or any other resident memory on game console 102. Generally, software modules include routines, programs, objects, components, data structures, etc. that perform particular tasks or implement particular abstract data types when executed by a processor in a computer or other device. The computer executable instructions may be stored on a computer readable medium such as a hard disk 208, removable storage media 108, solid state memory, RAM 206, etc. As will be appreciated by one of skill in the art, the functionality of the software modules may be combined or distributed as desired in various embodiments. In addition, the functionality may be embodied in whole or in part in firmware or hardware equivalents such as application specific integrated circuits (ASIC), field programmable gate arrays (FPGA), and the like.

One or more aspects of the invention may also or alternatively be implemented in a general purpose computer or other data processing device, such as is illustrated generally in FIG. 5. With reference to FIG. 5, an illustrative system for implementing various features includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506. Additionally, device 500 may also have additional features/functionality. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data instructing a device to operate as described herein. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Device 500 may also contain communications connection(s) 512 that allow the device to communicate with other devices. Communications connection(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 500 may also have input device(s) 514 such as keyboard, mouse, pen, voice input device, touch input device, etc. Output device(s) 516 such as a display, speakers, printer, etc. may also be included. All these devices are well know in the art and need not be discussed at length here.

Illustrative Embodiments—Action Charge System

A turn-based RPG may incorporate an improved battle system as described herein, referred to as the Action Charge System (ACS), according to one or more illustrative aspects of the invention. An ACS RPG may maintain a turn sequence to determine the order of each character's turn. Each turn may represent a specific period of time in the game, e.g., each turn may encompass 10 seconds of time in the virtual world represented by the game

Using the ACS a player can dynamically decide whether to instantly perform an action at a default power level at the player-character's next turn, or to defer the player-character's action to some later time but perform the action at an increased power level. That is, players can arbitrarily control the power (effect) delivered as a result of a certain action (e.g., attack, defense, heal, etc.), by “charging” the action for some amount of time from the player's initially allotted turn time. If the player decides to charge the action, the execution of the action is delayed, but the action will have more power when it is finally executed. Thus, the longer a player “charges,” or delays, the action (and thus the longer she delays her turn), the more powerful the charge affects the resultant power of the action when her turn occurs. This introduces a strategic option for players, as they must decide whether to perform an action quickly at a lower power level, or delay the action for some amount of time and perform the action at a higher power level. If a player delays an action to charge the action, the player must also decide how long (how much power) to charge the action, careful not to delay too long such that the player might lose the engagement as a result.

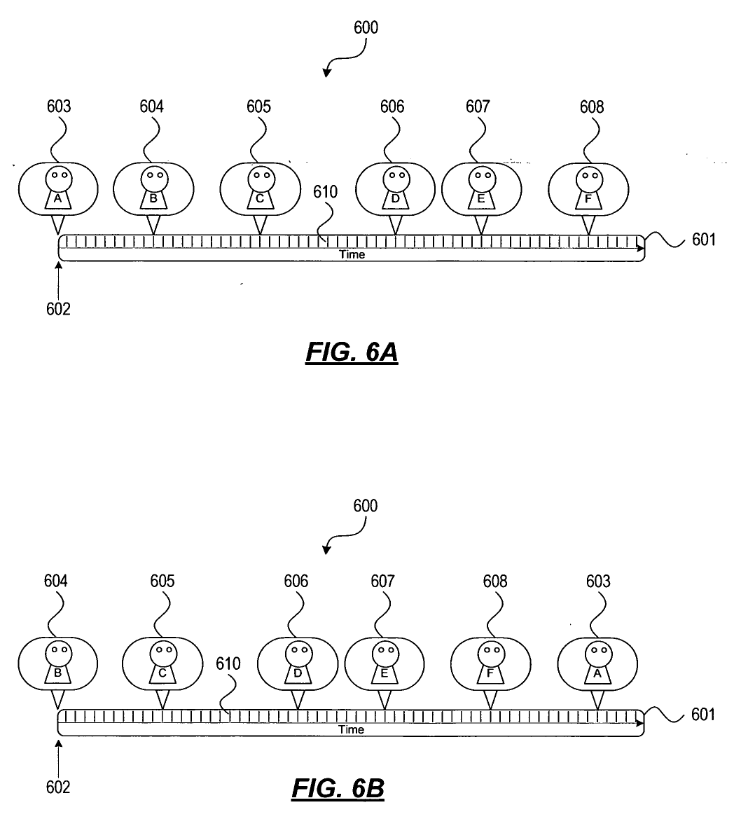

With reference to FIG. 6A, an illustrative turn-based RPG battle system may schedule a turn sequence 600 for character A 603, character B 604, character C 605, character D 606, character E 607, and character F 608 based on a timeline 601 having time increments 610. When a character's turn sequence coincides with a present game time 602, that character performs an action. As illustrated in FIG. 6A, character A 603 is shown to be at present time 602, and thus character A 603 can either perform an action instantly, or charge the power level for an action, as further described below. Character B 604 is scheduled for a turn 10 time increments after character A 603. Character C 605 will have a turn 11 time increments after character B 604. Character D 606 will have a turn 14 time increments after character C 605. Character E 607 will have a turn 9 time increments after character D 606. Character F 608 will have a turn 11 time increments after character E 607. Any time increment may be used, including 1 time increment per turn (and thus equally spaced turns), or more time increments per turns, as desired. The turn sequence 600 may be displayed as part of the video game's graphical user interface on a television or other display connected to game console 102 via A/V port 228, thus visually informing players of the current turn sequence.

When a character performs its turn, the ACS performs the requested action and revises the turn sequence based on a turn delay amount associated with the character that performed the action. For example, FIG. 6B illustrates the turn sequence 600 after character A 603 performs an instant action at a default power level, and where the turn delay associated with character A 603 is 66 time increments. A player-character may perform an instant action by entering a corresponding command, e.g., by pressing and quickly releasing a predesignated button 136 on game controller 104. The command need not depend on the duration of a button press, and any other command may be used to indicate an instant action is desired. The turn delay associated with a character may be based on various factors, such as a default turn delay amount as modified by zero or more modifiers such as a speed (typically a constant modifier based on the agility of a character), tiredness (may vary depending on lack of rest by the character), an enhancement modifier (typically a temporary modifier based on a magic spell, potion, or other temporary enhancement, e.g., because a speed spell was cast on the character, or the character upgraded its cyborg legs).

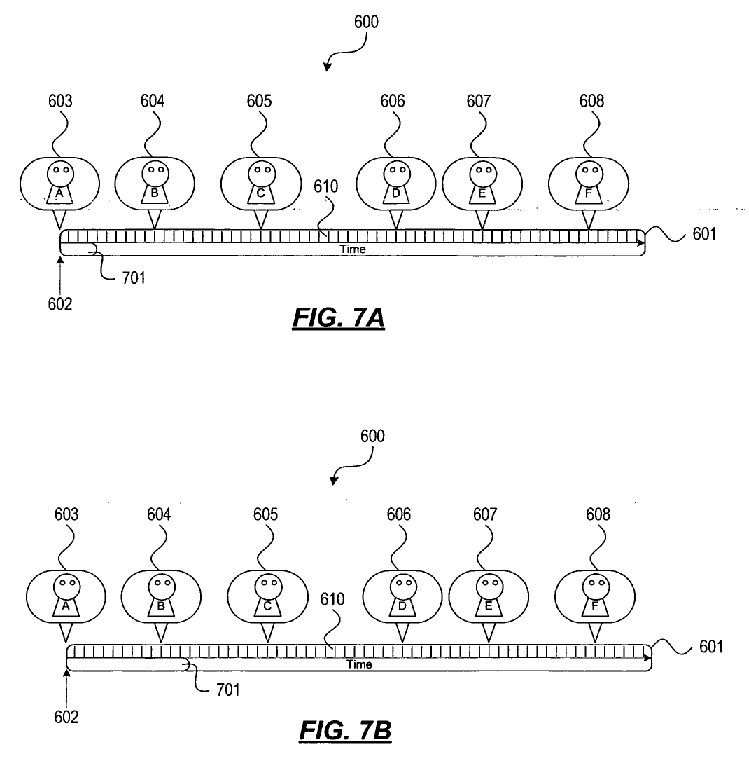

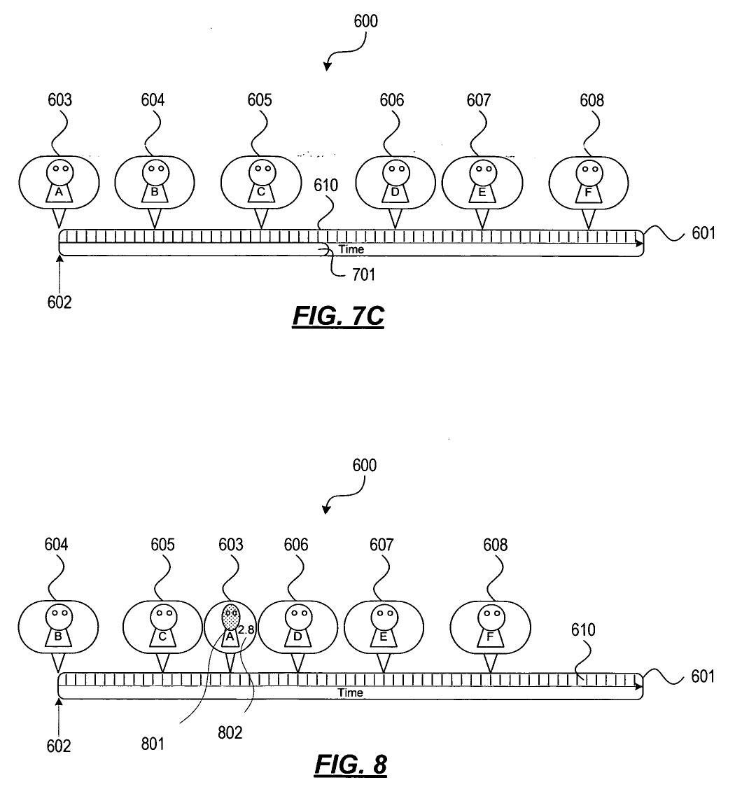

FIG. 7A illustrates the turn sequence 600 from FIG. 6A, except that instead of performing an instant action, the player controlling character A 603 (i.e., player-character A 603) decides to charge its action to achieve a higher power level when the action is executed. A player-character may charge an action by entering a corresponding command, e.g., by pressing and holding a predesignated button 136 on game controller 104. The same or a different predesignated button may be used as is used for instant actions. As the player holds down the predesignated button 136, an action meter or gauge 701 begins incrementing on the turn sequence 600 displayed as part of the video game's graphical user interface on a display or television connected to the ANV port 228. The longer the predesignated button is held down, the more the resulting action is charged. That is, a high charge yields a more powerful action, such as a more powerful attack, a better defense, more healing, etc. Again, as with the instant action command, the charge command need not depend on the duration of a button press, and any other command may be used to indicate an instant action is desired.

During the charging of an action, the player may be given feedback as to the amount of charge accumulated. For example, FIG. 7A illustrates action meter 701 that grows to the right as long as the action is charging. The example action meter 701 in FIG. 7A is in a state shortly after the player begins holding down the predesignated button, showing that the charge is not yet very high, but also that player-character A 603 could perform the thus-far charged action without delaying his or her turn. The meter may start at a level that at least forces character A to delay his or her turn past the expected turn of the next character (here, character B). Alternatively, there might be no charge effect until a predetermined minimum charge is reached. For example, the selected action being charged in FIG. 7A may be configured to only have a charge effect if the meter passes the next character's expected turn. In some aspects, a player may be given advance notice of the required charge for a charged action, so that the player can decide whether to use the charged version of the action. Thus, if the required charge appears instantaneously as the player presses the predesignated button, the player has time to determine whether to release the button and perform an instant action at a default power level, or allow the meter to proceed past the next character's expected turn, thereby charging the action, as shown in FIG. 7B.

FIG. 7B illustrates the action meter 701 in a state resulting from the player holding down the predesignated button long enough for the meter to surpass the next character's expected turn. As the player continues to hold the predesignated button, the meter will continue to charge, as illustrated in FIG. 7C. FIG. 7C illustrates the action meter 701 in a state resulting from the player holding down the predesignated button long enough for the meter to surpass the next two characters' expected turns. If the player releases the predesignated button when the meter is shown as in FIG. 7C, the action of player-character A 603 will be performed after character C 605 with a charge modifier based on the action meter, e.g., 28 time increments, or 28. Thus the action may be modified using a power modifier function based on the delay, e.g., cpl=ƒ(AM), where cpl is the charged power level and AM is the action meter value (28 in this example. Any power modifier function may be used to arrive at the charged power level, e.g., cpl=AM/10 (2.8 in this example), cpl=AM, or cpl=AMx (where x is any modifier or combination of modifiers. The power modifier function may vary depending on the time increments used, average time between turns, character modifiers, and the like. Alternatively, a charged version of the function may simply be selected over the instant (or uncharged) version.

While FIGS. 7A, 7B, and 7C illustrate the action meter 701 at certain points in time, the action meter 701 may be animated to grow over time in increments, or increments in steps sufficient to allow a player sufficient time to decide when to stop the charging of the action power level. The turn sequence illustrated in FIGS. 6-8 is merely one pictorial representation of a turn sequence 600 with timeline 602 and character icons 603-608, and that alternative designs or arrangements may be e used.

FIG. 8 illustrates turn sequence 600 after player-character A 603 has released the predesignated button, thereby charging the action for his or her turn. The turn sequence 600 of FIG. 8 illustrates that player-character A 603 has charged his or her power level enough such this the turn of character A 603 now occurs between characters C 605 and D 606.

FIG. 8 also illustrates optional indicia 801, 802. Optional indicator 801 (in this example, shading of the character's icon) indicates that character A has charged his or her power level for the next action, but does not indicate how much. The only indication evidenced by optional indicator 801 is that the resultant turn position of character A is after character C and before character D. Optional indicator may be any visual cue, such as shading, an asterisk by the character's icon or name, etc. Optional indicator 802 indicates the same information as optional indicator 801, but also provides some measurement of how much character A has charged his or her action for the next turn. Optional indicia 802 may comprise a displayed numerical value, a gradient or color of shading (where more than one shading color or gradient are used), or any other graphical indicator that provides a measure of the charged power level.

Optional indicators may be useful, e.g., when even after performing an action at a default power level, a first character's turn delay does not force the first character to the end of the turn sequence queue. That is, a first character might have a turn delay much higher than a second character, e.g., as a result of disparate speed modifiers. The ACS, upon completing an action with a default power level for the first character, might adjust the turn sequence based on a turn delay of 50 time increments for the first character. The ACS, 5 time increments later, and upon completing an action with a default power level for the second character, might adjust the turn sequence based on a turn delay of 40 time increments for the second character. The net result is that the second character has moved in front of the first character in the turn sequence by 5 time increments, yet both the first and second characters performed actions at the default power level. Thus, the fact that a character did not move to the end of the turn sequence is not a guarantee that the character charged his or her action power level. That is, the fact that a character does not move to the end of the turn sequence after a turn does not necessary infer that the character performed a charged action. Thus the optional indicia 801, 802 become useful to clearly point out to a player that a character has performed a charged action, and the player can react accordingly.

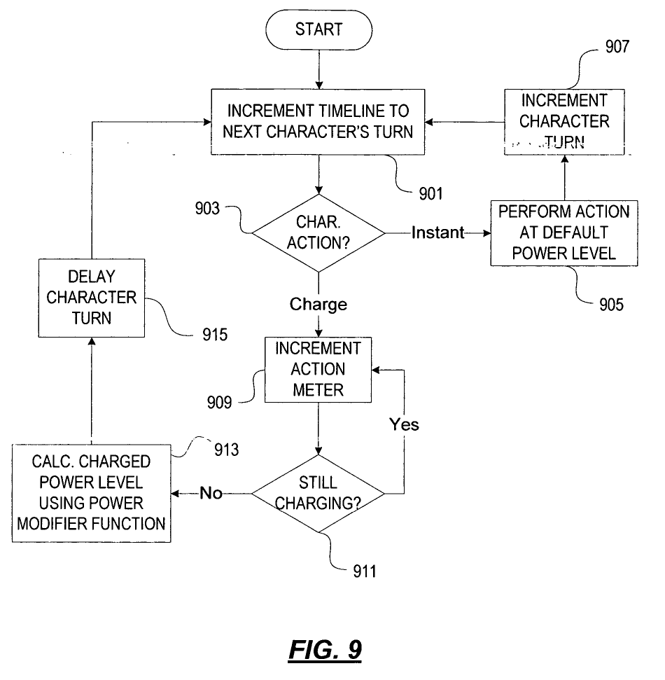

FIG. 9 illustrates an example flow chart for a method of charging a power level. After starting, in step 901 the ACS increments the timeline 601 to the next character's turn. In step 903 the player-character (or non-player-character using artificial intelligence) decides whether to perform an instant action at a default power level, or whether to charge the power level of the action for some amount of time or to some desired power level. If the character decides to perform an instant action, then in step 905 the ACS performs the action at the default power level. The default power level may be different for different characters, e.g., based on character specific attributes such as strength, agility, constitution, charisma, magic, etc. Upon performing the action with the character's default power level, the ACS increments the character's turn in step 907, and adjusts the turn sequence accordingly. The method then returns to step 901.

If in step 903 the character decides to charge the power level for an action, the method in step 909 increments the action meter 1 step (e.g., 1 time increment, or some other predetermined amount). In step 911, if the character is still charging the power level, e.g., by continuing to hold down the predesignated button 136, the method returns to step 909. If the character has stopped charging, e.g., by releasing the predesignated button, the ACS in step 913 calculates the charged power level using the power modifier function. In step 915 the ACS delays the character's turn based on the action meter, the charged power level, or based on some other predetermined value corresponding to the charged power level. The ACS then returns to step 901 to increment the turn sequence to the next character's turn. The steps illustrated in FIG. 9 may be performed in other than the recited order, and that one or more steps illustrated in FIG. 9 may be optional.

Using one or more aspects of the invention, a video game provides an additional level of strategy at player-characters' disposal. Non-player characters with suitable artificial intelligence can also take advantage of the additional level of strategy provided by the features described herein. For example, with reference to FIG. 8, characters B 604 and C 605 know that character A 603 has charged its action power level, evidenced by the display of optional indicia 801 and/or 802. Character B 604 must therefore strategize to determine whether character A's action might be directed at PC B, and determine whether to perform an immediate action at a default power level (e.g., a defense against character A's anticipated attack), or whether to charge his or her own attack power level. Alternatively, character B and character C might both decide to attack character A (e.g., because both character B and character C are on the same team) in the hope of defeating character A before character A's next turn. Still alternatively, character B might attack character C, knowing that character A will also likely attack character C, e.g., because character B and character A are on the same team.

The introduction of one or more aspects of the action charge system presents additional levels of strategy for players to take into consideration when determining what action to take on a character's turn. PCs and NPCs may decide whether to execute an action instantly at the default power level or to charge (increase) the power level of the action, thereby delaying his or her turn. If a character decides to charge the action power level, the character must also decide how much to charge the action power level—some arbitrary level, or some specific level based on the player's strategy.

As discussed above, a turn sequence (e.g., similar to turn sequence 600) may be displayed as part of the video game's graphical user interface on the television or other display device on which the video game is displayed, thereby informing the player-characters of the turn sequence as well as the resultant turn sequence based on an action charge. Players know when it is their turn to take an action or perform a charge, e.g., by viewing the representation of their character at the current time 602 in the turn sequence 600, and also know the current sequence of turn of some or all of the characters (dependent on the amount of visual space in which the turn sequence is displayed).

Using one or more aspects of the invention allows players to perform an action, such as a melee attack, a range attack, a magic attack, a defend posture, a healing event, or the like, with a dynamic charge level, but resulting in a delay to the player's turn, thereby likely causing the player to consciously consider the effects of his or her decision prior to making it. That is, should the player launch an immediate default level action, or wait and perform an action with a charged (increased) power level?

Various modifications and deviations may be made from the above description. For example, the ACS may set an upper limit on the allowed amount or time of charging. The upper limit may optionally change during game play, e.g., based on a character's development in the game and thereby enhancing players' motivation to develop their characters, and may change by increasing levels and/or through a functional algorithm.

In another variation, a video game may provide special abilities, powers, or enhancements, permanent or temporary, that affect the maximum charge amount. Such enhancements are referred to as rewards and penalties, and may include spells, potions, tokens, or other game play elements. A reward might result in a permanent or temporary increase in charge efficiency or ability, e.g., “Charge Power ×2” being attributed to a character, thereby allowing the character to charge twice as much or twice as fast (and thereby resulting in less charge-based turn delay). Other rewards may also or alternatively be used, e.g., charge power ×3, etc. Penalties detract from charging efficiency or ability, e.g., charge power ×½, charge power ×⅓, etc. Both rewards and penalties may be used on a player's own character, cast as a spell on another character, or otherwise as determined by the uses of the reward/penalty.

In yet another alternative, the action meter 701 might provide only an indication of turn order, and not charge amount (the charge might be based on the time, however). In another alternative, the time increments might be 1 time increment per turn (1 turn per time increment), and every character is moved to the end of the queue upon completion of an action (charged or uncharged) without regard to a character specific turn delay value. In such an embodiment, time increments may become irrelevant, and action charge is based on the amount of delay of a character's turn.

Illustrative Embodiments—Variable Action Gauge System (VAGS)

According to another illustrative aspect of the invention, a player may select a desired charge amount and the battle system may automatically determine how much time is required to charge the action power level to such a desired amount. This type of battle system is referred to herein as a Variable Action Gauge System (VAGS). That is, using the ACS battle system, players select the amount of time to charge the power level, and the result charge amount is based on the amount of time. Using the VAGS battle system, a player can select the desired charge amount, and the VAGS battle system determines the amount of time to charge to the desired charge amount.

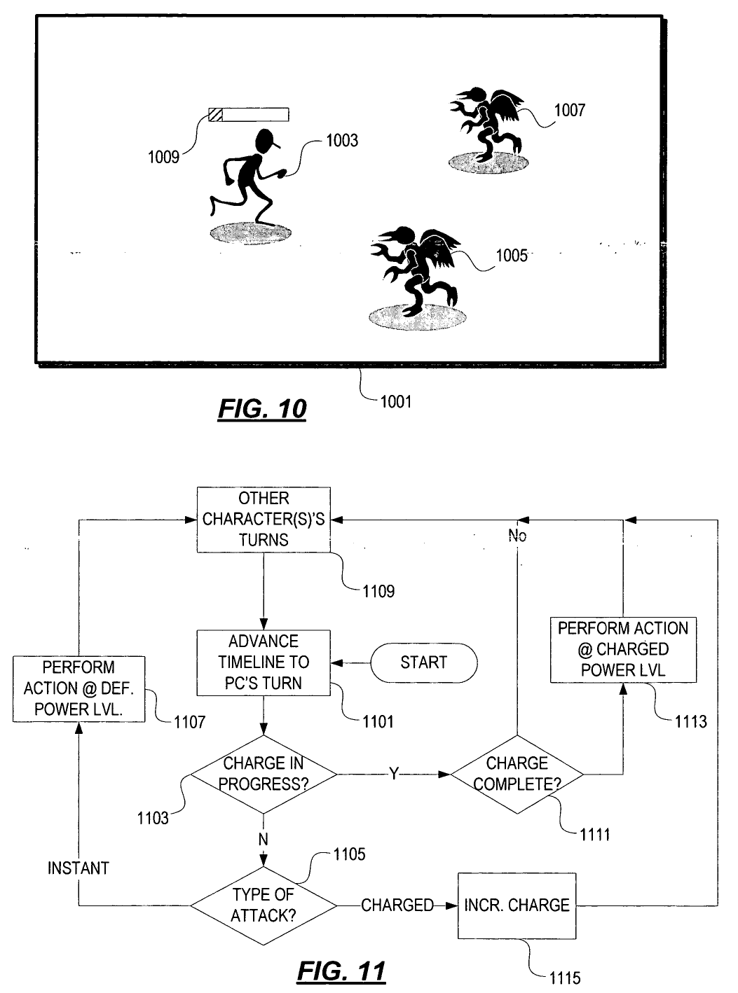

With reference to FIGS. 10 and 11, an illustrative method for affecting the power level using a VAGS battle system will now be described. FIG. 10 illustrates a graphical display 1001 depicting the output of a video game to a video game display device, here illustrating a player-character 1003 and two non-player-characters 1005, 1007. FIG. 11 illustrates a flowchart for a turn cycle method performed by the VAGS in accordance with one or more aspects of the invention.

In step 1101 the VAGS advances a game timeline to the player-character's turn. The VAGS determines, in step 1103, whether the player-character currently has a charge in progress (as described herein), e.g., as a result of a request from a previous turn to perform a charged action, e.g., attack ×2. If no charge is in progress, then at the player-character's turn, in step 1105 a player controlling the player-character 1003 may decide to perform an immediate action at a default power level (e.g., attack, cast spell, heal), or to perform the action at some charged power level, e.g., attack ×2, cast spell ×4, heal ×3, etc. Other options may also be available, but are unnecessary for the description provided herein. The player controlling the player-character can provide input, e.g., using controller 104 and input controls 132, 134, 136, etc., as is known in the art, to make the decision which action to pursue (that is, input mechanisms are known in the art, and need not be discussed in detail here). If the player decides to perform an instant action, then in step 1107 the VAGS performs the action at the default power level. In step 1109 the VAGS proceeds through other characters' turns, e.g., one or more other player-characters or non-player-characters. In this example the VAGS in step 1109 proceeds through the turns corresponding to non-player-characters 1005, 1007.

If in step 1105 the player-character opts to perform a charged action, then the VAGS stores information associated with the charged action, e.g., the type of action, a charge amount associated with the action level desired by the user, the object or recipient of the action, etc. In step 1115 the VAGS increments a charge meter 1009 corresponding to the player-character 1003. The VAGS may increment the charge meter 1009 a predetermined amount per turn. The predetermined amount per turn might be constant for all characters at all times, or it may vary based on one or more criteria. The predetermined amount may further be different for each character, e.g., based on attributes of each character. Examples of attributes that may affect the predetermined amount the VAGS increments the charge meter per turn might include strength (when the charged action, e.g., is a sword attack), magic ability (e.g., when the charged action is casting a spell), constitution (e.g., when the charged action is a healing action), character level, etc. These attributes are merely illustrative, and those of skill in the art will appreciate that the same or different values may be used to calculate the predetermined amount for each player in a variety of ways. From step 1115, the VAGS proceeds to step 1109 to perform other character's turns.

If in step 1103 the VAGS determines that a charged action is in progress, i.e., the player opted to perform a charged action in step 1105 in a previous turn cycle, the VAGS determines in step 1111 if the charge is complete. The VAGS may determine whether the charge is complete by determining whether the charge meter, represented visually as graphically depicted charge meter 1009, is full (i.e., the cumulative charge increments added during step 1115 of each turn cycle, optionally modified as described below, are equal to or greater than the charge amount associated with the action level desired by the user). If the charge is complete, then in step 1113 the VAGS performs the charged action according to the charged amount, the object of the action, etc., and proceeds to step 1109. If the charge is not complete in step 1111, then the VAGS proceeds to step 1109 without performing step 1113. Those skilled in the art will appreciate that the steps illustrated in FIG. 11 may be performed in other than the recited order, and that one or more steps illustrated in FIG. 11 may be optional.

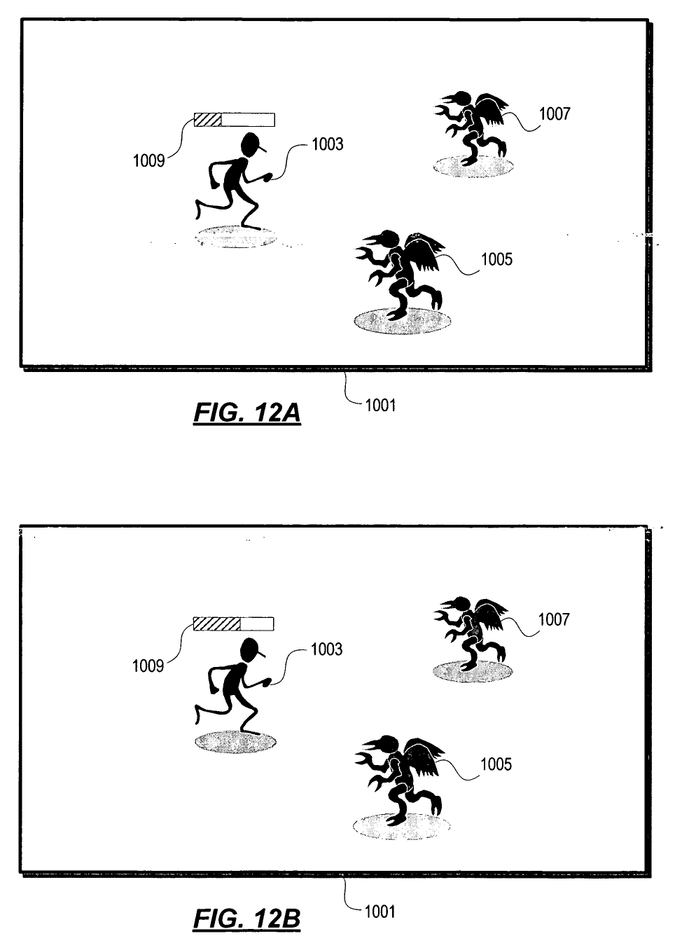

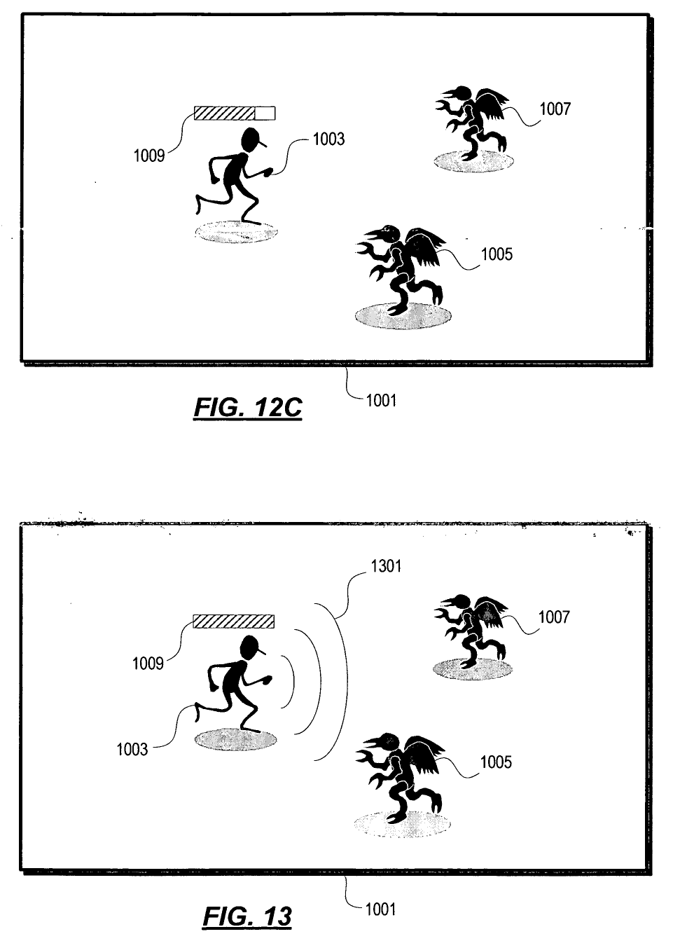

Using the above described method, a player might select in step 1105 to perform a charged action, such as an attack ×3. FIGS. 12A-12C illustrate action meter 1009 after two, three, and four turns, respectively, according to an illustrative embodiment of the invention. On the fifth turn, as illustrated in FIG. 13, the action meter 1009 is full, and the character thus performs the charged action 1301, e.g., attack ×3. More powerful charged actions may take longer charge times or amounts than lesser charged actions. For example, a given player-character may take 3 turns to charge an action ×2, but take 5 turns to charge the same action ×3.

According to one variation of the invention, when a player requests to perform an action at a default power level, there may still be a charge time associated with the action, albeit the charge time is less than the charge time required for a charged action. For example, a default action might only take one turn to charge. In addition, different types of actions may take different amounts of time to charge, even at the same charge multiplier. Thus, an attack ×2 action might take longer to charge than a defend ×2 action. Also, there may or may not be a limit to the allowed charge multipliers, depending on desired effect.

According to another variation of the invention, similar to the ACS battle system, a video game may provide rewards and/or penalties that affect the charge amounts or times. A reward might result in a permanent or temporary increase in charge efficiency or ability, e.g., “Charge Power ×2” being attributed to a character, thereby allowing the character to charge twice as much or twice as fast (and thereby resulting in less turns to fully charge the action). Other rewards may also or alternatively be used, e.g., charge power ×3, etc. Penalties detract from charging efficiency or ability, e.g., charge power ×½, charge power ×⅓, etc. Both rewards and penalties may be used on a player's own character, cast as a spell on another character, or otherwise as determined by the uses of the reward/penalty.

According to another variation of the invention, actions by characters (PCs and/or NPCs) other than the player-character may affect the charge time of the player-character. For example, while the player-character is charging an action, if the player-character takes damage as a result of an attack by an enemy, the charge meter 1009 may decrease some amount based on the action of the other character. Some actions may have more or less effect on the charge meter than others. As another example, if an enemy character casts a charge ×½ spell on the player character while the player-character is charging, then the charge increment per turn may be cut in half for the duration of the spell, while not actually decreasing the charge meter. As another example, a friendly character may defend the player character while the player-character is charging the action. The friendly character might cast a defensive spell on the player character, or might interfere between the player character and any enemy characters attempting to disrupt the player character's action charging.

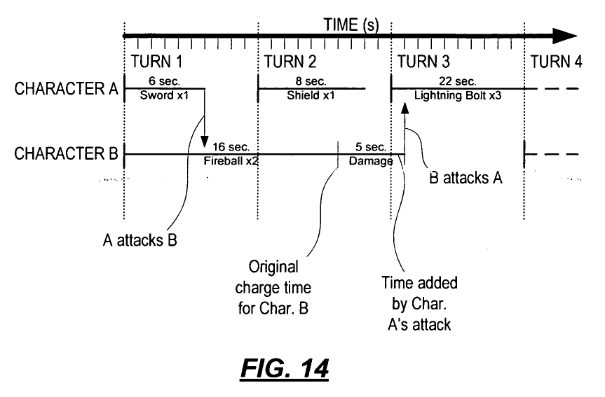

FIG. 14 illustrates a timeline according to an example use of the VAGS battle system in a turn-based video game, where each turn simulates ten seconds in the virtual world depicted in the video game, and each character can perform 1 action per turn. Characters are provided the opportunity to specify an action at the beginning of each turn for which they do not already have an action pending (charging).

At the beginning of turn 1, character A performs an action, e.g., a sword melee attack, at the default power level. In this example, such an attack takes six seconds to charge. As a result, the VAGS performs character A's action during turn 1. Also at the beginning of turn 1, character B performs an action, e.g., casting a fireball spell, at a charged power level, e.g., fireball ×2. In this example, such an attack takes 16 seconds to charge. As a result, the player controlling character B can expect that the fireball ×2 spell will be cast during turn two. However, if character A's attack is successful against character B, then character B's charge meter might get decreased as a result of character A's attack (in addition to or instead of character B sustaining damage), thereby adding some amount of time (e.g., 5 seconds) to the requisite charge time for character B to cast a fireball ×2 spell. As a result, instead of Character B casting its spell during turn two, character B now does not cast its spell until turn 3. Character A, meanwhile, can perform another action during turn 2, because character A completed its previous action during turn 1. In this example, Character A might perform another action at a default power level during turn 2, e.g., a shield (defense) spell, in anticipation of Character B's attack during turn 3. Character A might perform a charged action (its third action in as many turns) at the beginning of turn 3 e.g., lightning bolt ×3, whereas character B's original action is just being performed. Character B's fireball spell, if successful, may adversely affect Character A's charge time, just as Character A's sword attack did to Character B. The VAGS continues in similar fashion at turn 4. Thus, as is evident from this example, a player-character's charge time may be adversely affected by another character and, as a result, the player-character's action may be delayed to a subsequent turn.

The VAGS provides an additional level a strategy for use by player, because players must consider not only whether to charge an attack, but also how much to charge the attack. For example, after turn 1 in the above example, character A can determine (from a displayed charge meter corresponding to character B) that character B might not be able to perform its charged action until turn 3, which in turn causes character A to perform the shield spell. In various embodiments described above, player must take into account that the actions of other characters can adversely affect the charge time for the player-character's action. Those of skill in the art will appreciate the additional level of strategy this provides.

According to various illustrative aspects of the invention, the ACS and/or VAGS may be included in either single-player or multi-player turn-based role-playing games. Those of skill in the art will appreciate that various inputs and mechanisms may be used to perform an instant action, an ACS action charge, or a VAGS charged action. The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We Claim:

1. One or more computer-readable media storing computer-executable instructions for performing a method for affecting a power level of a character action in a turn-based video game, comprising steps of:
receiving user input corresponding to a player character in the turn-based video game, said player input requesting the player-character to perform a charged action in the video game;
determining a charge amount based on the requested charged action;
displaying a charge meter on a video game display device, said charge meter displayed correspondingly to a graphical depiction of the player character;
incrementing the charge meter a predetermined amount per turn of the player-character in the turn-based video game; and
when the charge meter is at least the same as the determined charge amount, performing the charged action by the player character in the video game.

2. The computer readable media of claim 1, wherein the predetermined amount per turn is based on one or more attributes of the player-character.

3. The computer readable media of claim 2, wherein the one or more attributes comprises a level of the player-character.

4. The computer readable media of claim 1, wherein each turn represents a first predetermined amount of time in a simulated environment of the video game, and the determined charge amount comprises a second predetermined amount of time in the simulated environment of the video game.

5. The computer readable media of claim 1, wherein the video game comprises a plurality of player-characters, and the charge meter is displayed on a separate video game display corresponding to each player character.

6. The computer readable media of claim 1, further comprising instructions for adversely affecting the charge meter based on an action of a second character in the turn-based video game.

7. The computer readable media of claim 6, wherein the action of the second character adversely affects the charge meter by decreasing the predetermined amount per turn.

8. The computer readable media of claim 6, wherein the action of the second character adversely affects the charge meter by decreasing the charge meter.

9. The computer readable media of claim 6, further comprising the step of delaying a turn in which the charged action of the player-character is performed as a result of the adverse affecting step.

10. The computer readable media of claim 1, further comprising instructions for associating a temporary modifier to the player-character, wherein the temporary modifier affects an amount of time to fill the charge meter.

11. The computer readable media of claim 10, wherein the predetermined amount per turn is further based on the temporary modifier.

12. The computer readable media of claim 10, wherein the determined charge amount is further based on the temporary modifier.

13. The computer readable media of claim 10, wherein the temporary modifier comprises a reward in the turn-based video game, said reward favorably affecting the amount of time to fill the charge meter.

14. The computer readable media of claim 10, wherein the temporary modifier comprises a penalty in the turn-based video game, said penalty adversely affecting the amount of time to fill the charge meter.

15. The computer readable media of claim 13, wherein the reward comprises a spell cast in the turn-based video game.

16. A method for altering a turn in which a character performs a charged action in a turn-based video game, comprising steps of:
receiving user input corresponding to a player character in the turn-based video game, said player input requesting the player-character perform a charged action in the video game;
determining a charge amount based on the requested charged action;
displaying a charge meter on a video game display device, said charge meter displayed correspondingly to a graphical depiction of the player character;
incrementing the charge meter a predetermined amount per turn of the player-character in the turn-based video game, wherein each turn represents a predetermined amount of time in a simulated environment of the turn-based video game, such that the charged action is expected to be performed during a first turn in which the charge meter is full;
adversely affecting the charge meter by a second character to delay the charged action to a second turn, subsequent to the first turn; and
when the charge meter is at least the same as the determined charge amount, performing the charged action by the player character in the video game.

17. The method of claim 16, wherein adversely affecting comprises the second character attacking the player character in the turn-based video game.

18. The method of claim 16, wherein adversely affecting comprises the second character casting a spell on the player character in the turn-based video game.

19. The method of claim 16, wherein prior to the adversely affecting step, a third character interferes with the adverse effect caused by the second character, thereby deflecting the adverse affect away from the player-character such that the charged action is performed during the first turn.

20. One or more computer-readable media storing computer-executable instructions for performing a method for affecting a power level of a character action in a turn-based video game, comprising steps of:
receiving user input corresponding to a player character in the turn-based video game, said player input requesting the player-character to perform an action in the video game;
determining that the requested action is associated with a multi-turn preparation time;
when a number of turns corresponding to the multi-turn preparation time have lapsed, performing the charged action by the player character in the video game.
